(19) United States
(12) Patent Application Publication
(10) Pub. No.: US 2004/0088704 A1
(43) Pub. Date: May 6, 2004

(54) Method for running real-time tasks alongside a general purpose operating system

(75) Inventors: Kevin Owen, Crozet, VA (US); Robert Butterfield, Herndon, VA (US)

Correspondence Address: Wayne C. Jaeschke, Jr., Morrison & Foerster LLP, Suite 300, 1650 Tysons Boulevard, McLean, VA, 22102, US

(73) Assignee: Advanced Simulation Technology, Inc., Herndon, VA

(21) Appl. No.: 10/303,998

(22) Filed: Nov. 26, 2002

Related U.S. Application Data
(60) Provisional application No. 60/422,108, filed on Oct. 30, 2002.

(51) Int. Cl. G06F 9/00

(52) U.S. Cl. 718/100

(57) ABSTRACT

A method for running real time tasks alongside a general purpose operating system, such that the real-time tasks are not pre-emptible by the general purpose operating system, and the general purpose operating system runs as if the real-time tasks were not present. This is achieved by disabling all interrupts except one, which is given to the real time tasks, and then periodically polling the hardware devices, notifying the general purpose operating system of hardware events and the passage of time as and when is necessary.

### FIELD OF THE INVENTION

The present invention relates to a method for enabling the running of real-time tasks alongside a general purpose operating system.

### BACKGROUND OF THE INVENTION

Modern general purpose operating systems are designed to be able to run many tasks concurrently by interleaving the execution of each task with the other tasks running on the same machine using some scheduling algorithm. When external events occur, the delay between the event occurrence and interested tasks responding to it is unpredictable and relatively slow. This is because the scheduling algorithm balances the benefit of responding quickly to external events against the need to ensure all tasks get some processor time regularly. For general purpose operating systems, an unpredictable and relatively slow response to external events is acceptable in most cases, as the scheduling algorithms involved try to limit response times so that they are barely, if at all perceptible to a user, and still manage to give each task enough processor time to appear to be continuously running.

However, there are some applications for which an unpredictable and slow response time is unacceptable, mostly for the reason that a response that takes too long or is not guaranteed to occur within a certain interval will result in a system failure. For example when a driver brakes heavily in a car that is equipped with anti-lock braking, it is imperative that the car's computer system responds to the brake pedal depression within a bounded period of time; if the response time is one second as opposed to 1/100 of a second this could make a difference of tens of meters in stopping distance when driving at speed, with potentially catastrophic results. In an industrial bottling plant, when a computer controlled machine places bottle caps on bottles passing at high speed on a conveyor belt, it is important that the response time from sensing a bottle to placing the cap on it is predictable, otherwise the machine will fail its task, by occasionally missing the bottles. There are many applications in the automotive, aviation, industrial and military fields that also require deterministic, fast response times in order to avoid system failure.

There is another category of applications that can still work if a deterministic fast response time is not guaranteed, but work much better when a fast response time can be guaranteed. For example, any application that processes audio or video has to make sure that it never runs out of input data to process; if the application gains control of the CPU at varying intervals of time, it must buffer enough of the incoming data stream so that the buffer never runs out between successive processing iterations. Conversely, if the audio/video application gets control of the CPU at guaranteed intervals of time, it can buffer a much smaller amount of the incoming data stream, reducing processing delays. Although applications in this category do not actually fail if their response time is not particularly fast or predictable, the faster and more predictable the response time, the better the application appears to run.

These two categories of applications, that require fast, deterministic response times, and applications that work much better in these conditions, correspond loosely to two definitions of real-time computing systems—hard and soft real-time systems. See, chapter 2, Real-Time Systems, Jane W. S. Liu, Prentice Hall 2000. Hard real time systems are characterized as having constraints, or deadlines, which must be met, otherwise the system is deemed to have failed. Although the constraints placed upon hard real-time systems are sometimes fixed, and sometimes probabilistic, a working system must be able to guarantee that the constraints are met. Soft real-time systems also have deadlines and constraints, but the constraints are more blurred, such that it may be acceptable to occasionally miss the constraints or deadlines, so long as the majority of the time the performance is within the constraints. Hard real-time systems are difficult and therefore expensive to design, implement and support, but the importance of their goals is such that the reduced cost associated with relaxing the constraints is greatly outweighed by the cost of missing the system goals. Soft real-time systems are like hard real-times systems whose constraints and requirements have been relaxed as much as possible, for the purpose of ease of implementation, but have not quite reached the point where performance degrades to become annoying.

Commercial real-time operating systems, for example VxWorks by Wind River Systems (www.windriver.com) normally have the capability to mix hard and soft real-time operation as required. These operating systems are usually simpler and smaller than a general purpose operating system, so that it is easier to guarantee that certain things will happen at certain times, and because a lot of the features of a general purpose operating system are simply not required in real-time systems. However they are difficult to work with, partly because they are used for demanding applications whose goals must be guaranteed to be met, but also because it is more difficult to debug real-time applications, and the capabilities for doing so are lesser than available in general purpose operating systems.

Some general purpose operating systems provide soft real-time features by prioritizing tasks that are marked as “real-time” over regular tasks, such as those described in Operating System Concepts, 5th Edition, SilberSchatz, A. & Galvin, P. B., Addison Wesley, 1998. This improves the response time of the “real-time” tasks by a certain amount but there is a fundamental difficulty associated with process synchronization that prevents general purpose operating systems from achieving hard real-time performance for any of their tasks. Process synchronization is the ability of the operating system to arbitrate processes' access to shared system resources, so that once one process is in the middle of altering some shared resource, no other processes are allowed to alter the same resource, otherwise the shared resource would be in an inconsistent, half-altered state in the eyes of the other processes. The sections of code that access such shared resources are called ‘critical sections’, which only one, or a finite number of processes can be executing at a given time. To the perception of the rest of the system, once a given process enters a ‘critical section’ it completes the operation in one go without interruption, in an indivisible, or ‘atomic’ transaction. The simplest way to achieve an atomic transaction is to disable interrupts once a process enters the critical section, and re-enable interrupts once the process leaves the ‘critical section’. This method is easy to implement in operating systems, but it means that for the duration of the ‘critical section’ no process can be made aware of external events, because interrupts are disabled, and interrupts are how external events are noticed by the system.

‘Critical sections’ can be relatively large pieces of code, resulting in periods of tens of milliseconds during which the system can not respond to external events. This time can be reduced by maintaining data structures (semaphores, spin locks etc.) that represent ‘critical sections’, and by only disabling interrupts while the representative data structures are accessed, and using the data structures to arbitrate access to the ‘critical sections’. This finer-grained synchronization improves the response time of general purpose operating systems, but does not eradicate the problem that, due to synchronization requirements, at any given time interrupts may be disabled, thus preventing external events from being noticed by processes. When a process disables interrupts in this way, it is in effect pre-empting, or preventing from running, any other process, for the duration that interrupts are disabled. This is a fundamental problem that prevents general purpose operating systems from achieving hard real-time performance for any of their processes in a generic way.

The ability to run a handful of hard real-time processes on a machine that otherwise runs a general purpose operating system would be very useful for improving the performance of the system with respect to time-sensitive applications such as multimedia applications, but retaining all the features of the general purpose operating system. There is an existing solution to this, described by Yodaiken in U.S. Pat. No. 5,995,745, which is hereby incorporated by reference in its entirety, that runs a general purpose operating system as the idle task of a real-time operating system, and only passes on the interrupts to the general purpose operating system after the real-time operating system has finished with them. However this is a complicated system, whose implementation entails substantial platform-dependent modifications to a general purpose operating system which can require on the order of three man-months of work from an exceptional engineer.

It is therefore desirable to provide an alternative way to add real-time functionality to a general purpose operating system using an alternate method, where all interrupts are turned off except one, primary interrupt, which is used to run real-time tasks and regularly poll all the hardware devices on the system. Such an approach would take advantage of advances in hardware which allow devices be polled rather than be interrupt driven, and results in a much simpler way to add this functionality to a general purpose operating system. Such a task would preferably involve much less platform-dependent work, and takes approximately 25% of the time of the Yodaiken method to implement, all else being equal. In this way we believe a more elegant and easier to implement solution to adding real-time functionality to a general purpose operating system could be provided.

### SUMMARY OF THE INVENTION

This invention relates to a process for adding the capability to run one or more non pre-emptible real-time tasks to a general purpose operating system without interfering with the operation of the general purpose operating system. The general purpose tasks are not able to pre-empt the real-time tasks, but the higher priority real-time tasks can interrupt and pre-empt the general purpose tasks. A comparison of a general purpose operating system's execution of tasks, and the same operating system modified to run a pool of regular tasks and a pool of real-time tasks is show in FIG. 1. This additional capability is achieved by making a relatively small number of modifications to the general purpose operating system, which makes the process easy to apply to different operating systems running on a range of processors. The real-time tasks are made non pre-emptible by preventing the general purpose operating system from disabling and enabling interrupts. Hardware device interrupts are prevented from pre-empting real time tasks by disabling all the interrupts except one primary interrupt, whose interrupt service routine (ISR) is changed to a custom ISR that passes control to the real time tasks.

Regular operation of the general purpose operating system is maintained by periodically polling the hardware devices in the system from the primary interrupt service routine, to compensate for the devices' disabled dedicated interrupts. A similar method is used to periodically inform the general purpose operating system of the passage of time. Polling of hardware devices, and notification of the passage of time is deferred when doing so would access a shared system resource that the general purpose operating system is currently using. This is achieved automatically by intercepting the commands that the general purpose operating system uses to enable and disable interrupts, and replacing them with commands that maintain a flag representing the general purpose operating system's disposition towards interrupts, but do not actually enable and disable interrupts. When this flag is set and hardware device polling would ordinarily occur, the polling is deferred, until the general purpose operating system tries to re-enable interrupts. At this time the polling can be safely carried out, as the shared resource is no longer being accessed.

### BRIEF DESCRIPTION OF THE DRAWINGS

FIG. 1 shows an example of a comparison of task pools and task execution in time for unmodified general-purpose operating system, and same system with real-time tasks added.

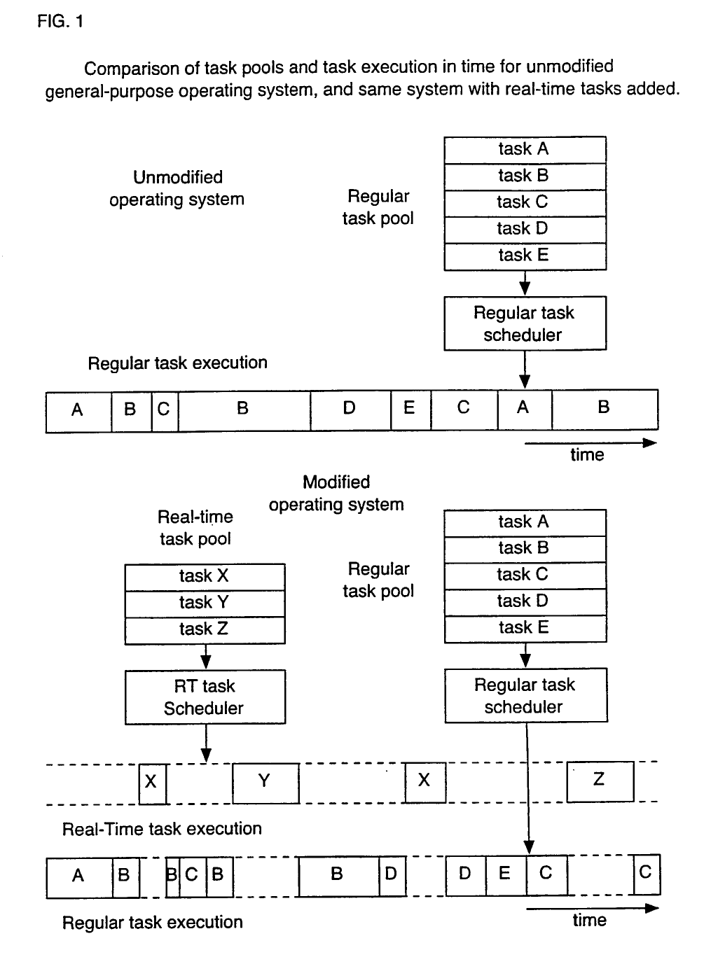

FIG. 2 illustrates an exemplary relationship between the CPU, interrupt controller, interrupt service routines and the regular task scheduler.

FIG. 3 shows task B pre-empted by task A, disabling interrupts.

FIG. 4 is an example of where a task is preempted by interrupt A service routine running with interrupts disabled.

FIG. 5 shows an example of a system with all interrupts disabled except the primary interrupt, passing control to the real-time scheduler.

FIG. 6 shows an example of a comparison of network interface card operation when receiving packets, using interrupts when the interrupt is pre-empted, and using polling.

FIG. 7 shows an example of the role of the custom interrupt service routine logic in the modified operating system.

FIG. 8 is an example of how the primary interrupt is scheduled to meet the demands of real-time task scheduling and hardware device polling, when the primary interrupt is a timer interrupt.

FIG. 9 is an example of how the primary interrupt is scheduled to meet the demands of real-time task scheduling and hardware device polling, when the primary interrupt is a fixed rate periodic interrupt.

FIG. 10 is an example of a polled device interrupt service routine entering a ‘critical section’ at the same time as general purpose operating system task.

FIG. 11 shows an example of the relation of intercepted enable/disable interrupt commands in general purpose operating system to logic in custom ISR.

FIG. 12 shows an example of comparison of regular polling operation and operation when polling is temporarily disabled due to a task entering a ‘critical section’.

FIG. 13 shows an example of comparison of regular polling operation and deferred polling operation, the deferred polls running with interrupts disabled to minimize data loss from hardware devices due to buffer overflow.

FIG. 14 shows an example of a comparison of regular polling operation and deferred polling operation, the deferred polls running with interrupts enabled, to minimize data loss from hardware devices and to prevent jitter in real-time task scheduling.

### DETAILED DESCRIPTION OF THE INVENTION

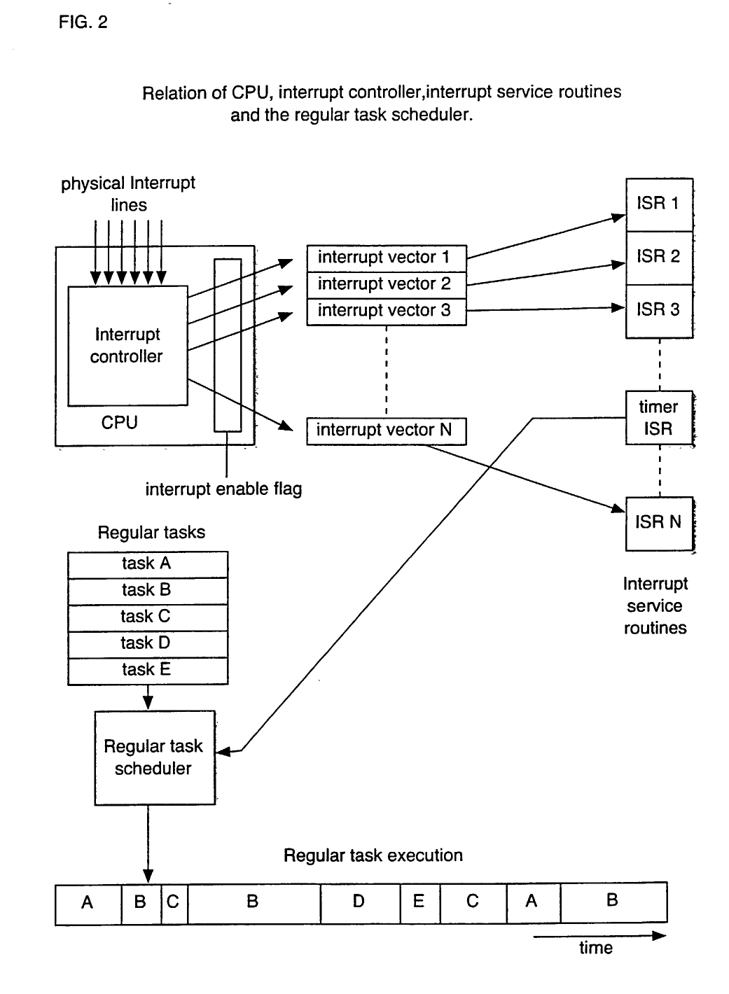

Modern operating systems and CPUs deal with interrupts through an interrupt controller, which has several physical interrupt lines that devices can signal an interrupt condition on. The interrupt controller signals the CPU that a particular interrupt has occurred, which arranges for a particular interrupt service routine (ISR) to be called, out of a table of ISRs, one for each interrupt source, as shown in FIG. 2. Each CPU generally has a mechanism for disabling and enabling interrupts, so that when the operating system enters certain sections of code that should be executed atomically (i.e., having exclusive, uninterrupted control of the CPU), it is possible to disable interrupts to ensure this is the case. One of the sources of unpredictable response time and latency in general purpose operating systems is the ability of individual tasks or processes to disable interrupts so that they can complete an operation atomically. This is necessary when a task is about to access or change a shared system resource that could also be changed from an interrupt, in order to synchronize and serialize access to the shared system resource. The section of code that a task runs with interrupts disabled, and accesses or modifies a shared system resource, is known as a ‘critical section’, because it is, in general, critical to the integrity of the system that this operation is performed atomically.

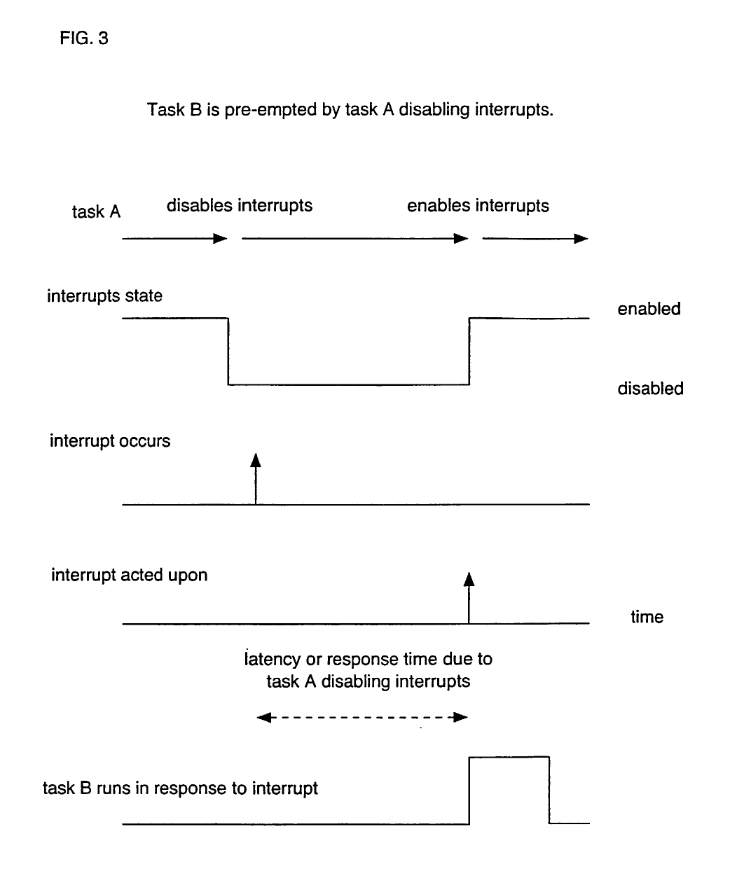

Depending on the length of each possible ‘critical section’ that a task can execute, there is a variable amount of time during which the occurrence of external events, normally communicated by interrupts, is disregarded until interrupts are re-enabled. At which time, the external event interrupts that had occurred in the meantime are noticed by the system. Any task or process running on the same machine as processes that are able to disable and enable interrupts is liable to be pre-empted at any time. More specifically, a task that expects to run at a certain time, or directly in response to an external event (interrupt) will be delayed or pre-empted, if at the time it would ordinarily run another process has temporarily disabled interrupts in order to perform an atomic operation. This aspect of the invention is illustrated in FIG. 3.

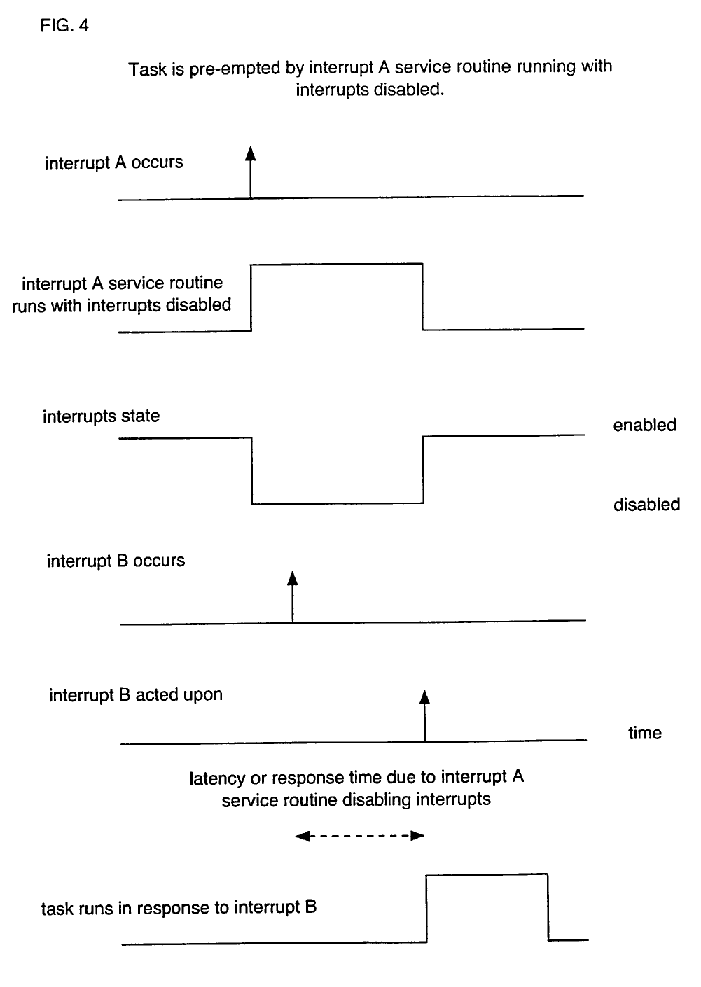

Another way that a task can be pre-empted is for the code that runs in an interrupt service routine (ISR) to include ‘critical sections’ that need to atomically access a shared system resource (i.e., the ISR should, and in many cases must, have exclusive, uninterrupted access to the shared system resource). Some interrupt service routines have ‘critical sections’, others have no ‘critical sections’, and still others run in their entirety with interrupts disabled, in effect making the whole ISR a ‘critical section’. If an interrupt service routine is running code in a ‘critical section’ at the time a task expected to run in response to another interrupt, then the task will be pre-empted until the ISR leaves the ‘critical section’. The pre-emption of a task by an interrupt service routine that runs with interrupts disabled is shown in FIG. 4.

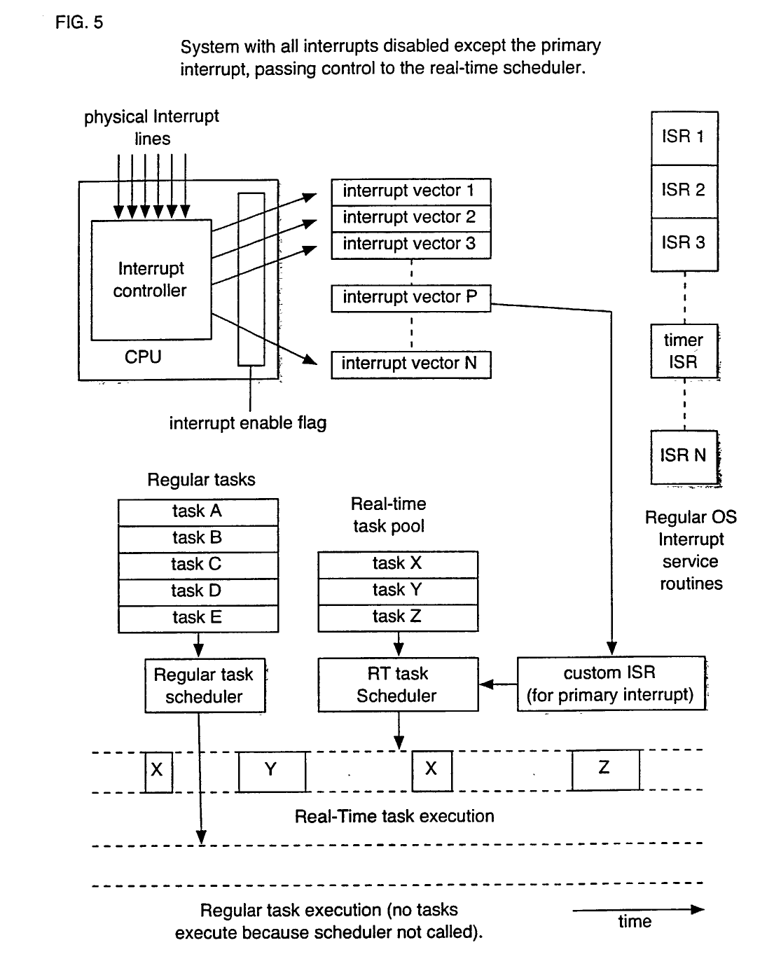

In order to add one or more non-preemptible real-time tasks to a general purpose operating system, both these causes of pre-emption should be stopped from pre-empting the real-time tasks. The general purpose operating system tasks can be prevented from disabling interrupts quite easily, because the assembly language instructions that disable and enable interrupts on a CPU can be readily identified, either in the source code, when the instructions are mnemonics, or in the binary image of the operating system, when the instructions are unique opcodes. This means that it is possible to find each occurrence of these instructions, manually or by an automated process, and replace each disable and enable interrupt instruction around any ‘critical sections’ with counterparts that do not disable and enable interrupts. In order to stop other interrupts from pre-empting real-time tasks, all the interrupts can be disabled except one, primary interrupt, which is the interrupt that causes the real-time task or tasks to run at prescribed times, or in response to certain events. The interrupt service routine for the primary interrupt is changed to a custom interrupt service routine, which passes control to a scheduler for the real-time tasks on the system, which can invoke individual real-time tasks. The system with all interrupts disabled except the primary interrupt, passing control to the real-time scheduler, is shown in FIG. 5.

After these modifications, the real-time tasks will run without danger of pre-emption, but the general purpose operating system will not operate normally, because the interrupts it would ordinarily receive from hardware devices are no longer enabled, or in the case of the primary interrupt, enabled but with a custom interrupt service routine that does not do what the old interrupt service routine did. In reality, as the timer interrupt ISR is the normal entry point for the general purpose operating system's scheduler (for modern, pre-emptive multitasking operating systems), regular tasks will, generally, not run. Clearly, further modifications to the general purpose operating system are necessary so that this is not the case. More specifically, for it to operate as normal it must run as if the disabled interrupts were not disabled. This can be achieved by taking advantage of some features of modern hardware devices and operating systems that make it possible to achieve the same effect as enabling the disabled interrupts through regular polling of the devices. The fundamental purpose of an interrupt is to urgently notify a processor and its operating system that something has happened, some data is ready to be read, or written, or some similar event has occurred. Historically, operating systems have been designed to respond to interrupts as quickly as possible, but in recent times, several changes have occurred that make a rapid response to interrupts less critical.

As previously discussed, modern multi-tasking operating systems suffer from latency problems when tasks or ISRs disable interrupts while in ‘critical sections’ that access shared system resources. This means that if a hardware device generates an interrupt while interrupts are disabled, due to the execution of a ‘critical section’, it could be several milliseconds or more before interrupts are enabled again and the operating system can act on the device's interrupt. Recent hardware devices support very high data rates, so that in these milliseconds, more data could arrive at the device, meaning that the device has to buffer all the data that arrives until the interrupt is seen by the operating system to prevent data loss. The efficiency and prevalence of direct memory access (DMA), and the low cost of memory mean that most if not all hardware devices that send or receive data now have large memory buffers that hold all the data that arrived since the operating system last emptied them. In practice to avoid data loss the buffers have to be at least as large as the data that can arrive at the device in the time period of the worst-case latency that can occur with the particular operating system used. Based on this, it would be reasonable to assume that manufacturers error on the side of caution and make their devices' buffers larger than is strictly necessary, rather than run the risk of lost data.

One other factor that enables the use of device polling instead of actual interrupts, is that physical interrupt line sharing is now commonplace with hardware devices. This means that if two different devices share the same interrupt line, then when an interrupt occurs, each device's interrupt service routine (ISR) has to be called, to check whether it caused the interrupt and has to act upon it, or whether some other device that is sharing the same interrupt line caused the interrupt. This means that it is inherently safe to call the interrupt service routines for devices that are able to share interrupts, at any time, not just when the device tries to cause an interrupt.

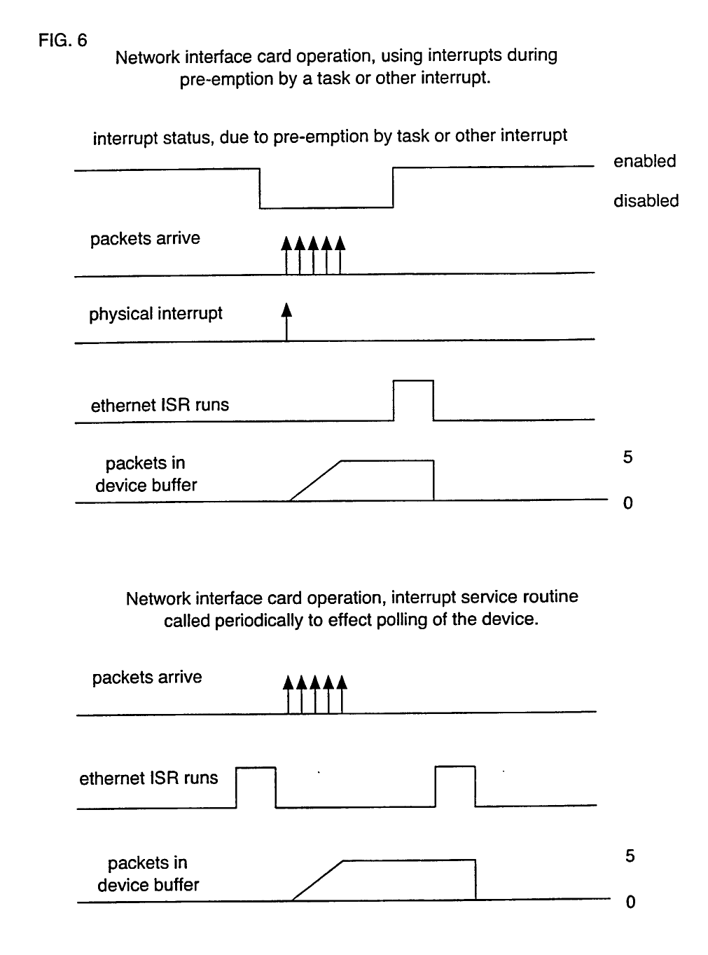

In combination, the latency of modern operating systems, the use of buffers and DMA in devices, and the ability of devices to share interrupts mean that most devices work perfectly well if their interrupt service routines are called frequently enough, regardless of whether the ISRs are called from dedicated interrupts, or at regularly scheduled times. A comparison of the behavior of a hardware device when its ISR is called from an interrupt that has been delayed by pre-emption, and when the ISR is just called periodically, is shown in FIG. 6., for the case of a network interface card receiving packets.

General purpose operating systems use hardware timers to generate timer interrupts that are used to measure the progression of time, the main use of which is to determine in the regular task scheduler when it is appropriate to exchange the currently running task for another one. In order to let the general purpose operating system know that a unit of time has passed, its timer interrupt service routine can be called, which is the equivalent of polling the hardware device through their ISRs. As long as this routine is called the same number of times as the general purpose operating system expects timer interrupts to occur, over a reasonable period of time, the general purpose operating system will operate largely as if the timer interrupt was still enabled.

The periodic polling of hardware devices, and simulation of the timer interrupt to the general purpose operating system is achieved by calling the hardware devices' ISRs and the general purpose operating system's timer interrupt ISR from the primary interrupt, after the real-time tasks have been run. It is simple to call these ISRs because in most operating systems, device drivers register their ISRs to the system, so are easily accessible. Although polling should occur frequently enough that data is not lost from the device buffers, it does not have to occur more frequently than this, and similarly if it is not possible to poll frequently enough due to the demands of the non pre-emptible real-time tasks, then this is acceptable, the only consequence being possible data loss.

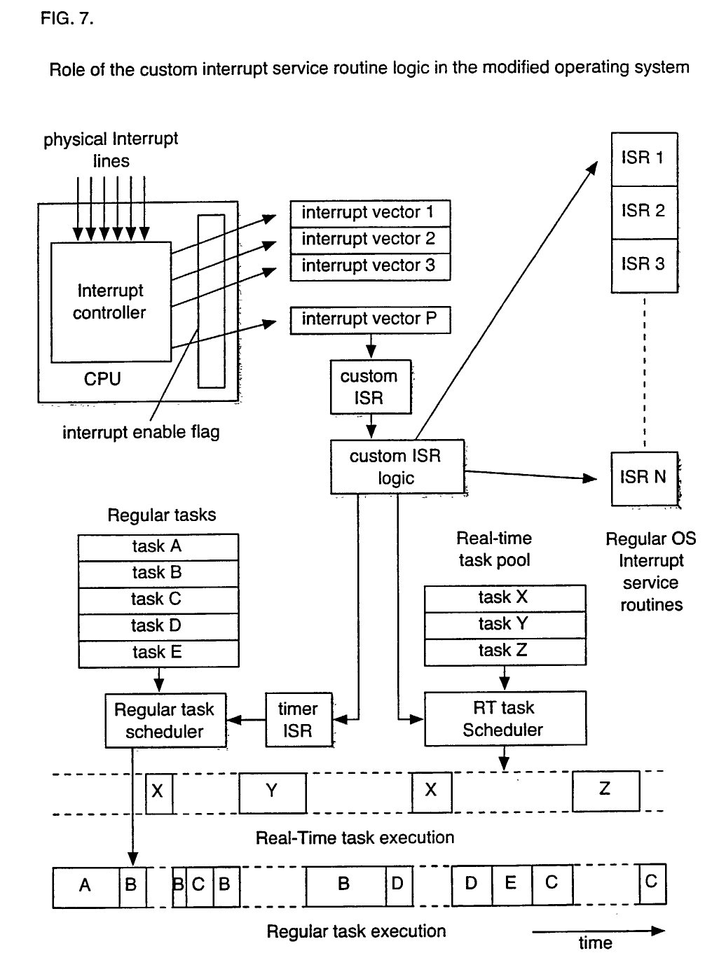

Whenever the primary interrupt occurs, some logic has to decide whether to run the real-time tasks, and then whether to poll the devices and notify the general purpose operating system of the passage of a unit of time, by calling the original timer interrupt ISR. The relation of this logic to the primary interrupt, the real-time and regular schedulers and the original ISRs is shown in FIG. 7. The primary purpose of this logic is to ensure that whenever a real-time task is scheduled to occur, it will occur; a secondary goal is to, whenever possible, ensure that the polling occurs frequently enough that data is not lost in hardware device buffers, and the general purpose operating system is kept adequately informed of the passage of time. The logic used to do this depends on the nature of the primary interrupt.

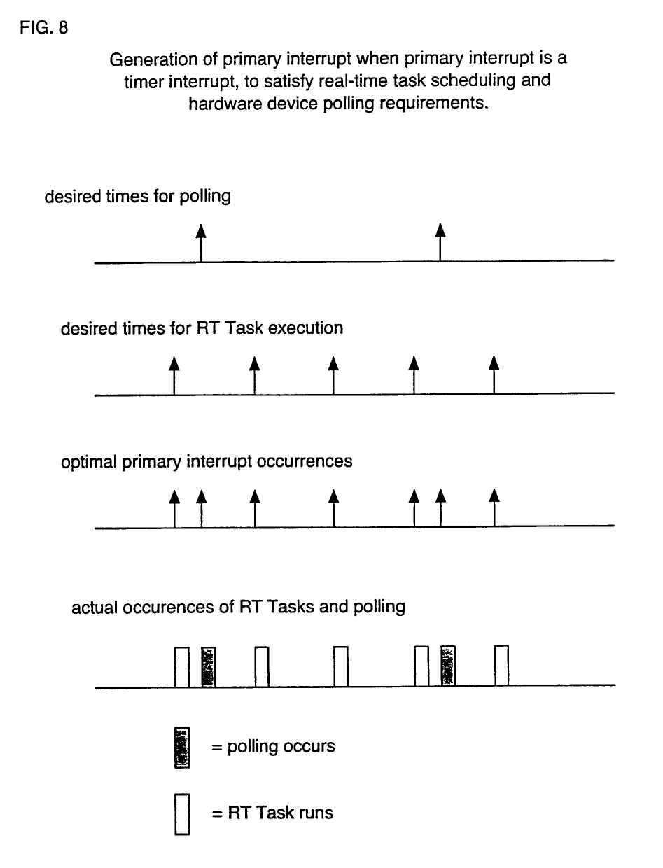

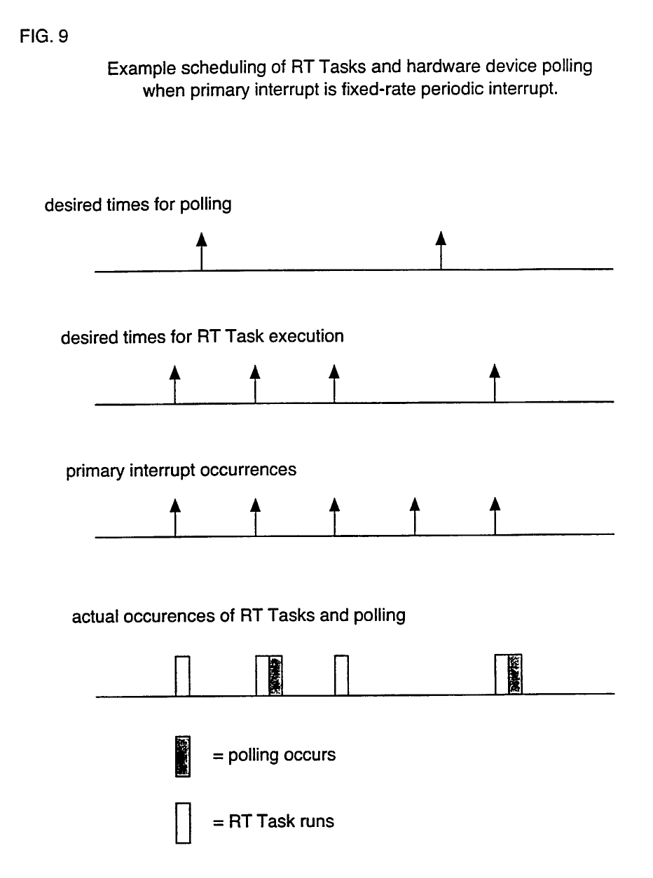

If the primary interrupt is a timer interrupt, then the logic has the power to schedule the next timer interrupt to try and meet its two prioritized goals. This can lead to timer interrupts that do not call real-time tasks, and only poll the hardware devices, so long as doing so will not interfere with the scheduling of real-time tasks. An example of this scheduling, with a timer interrupt as the primary interrupt is shown in FIG. 8. If the primary interrupt is a fixed-rate periodic interrupt, then the logic is simpler but still works in much the same way, so that primary interrupts can cause either, both, or none of the real-time tasks and polling to be run, so long as real-time tasks are treated with higher priority. An example of scheduling for real-time tasks and polling, when the primary interrupt is a period fixed rate interrupt, is shown in FIG. 9.

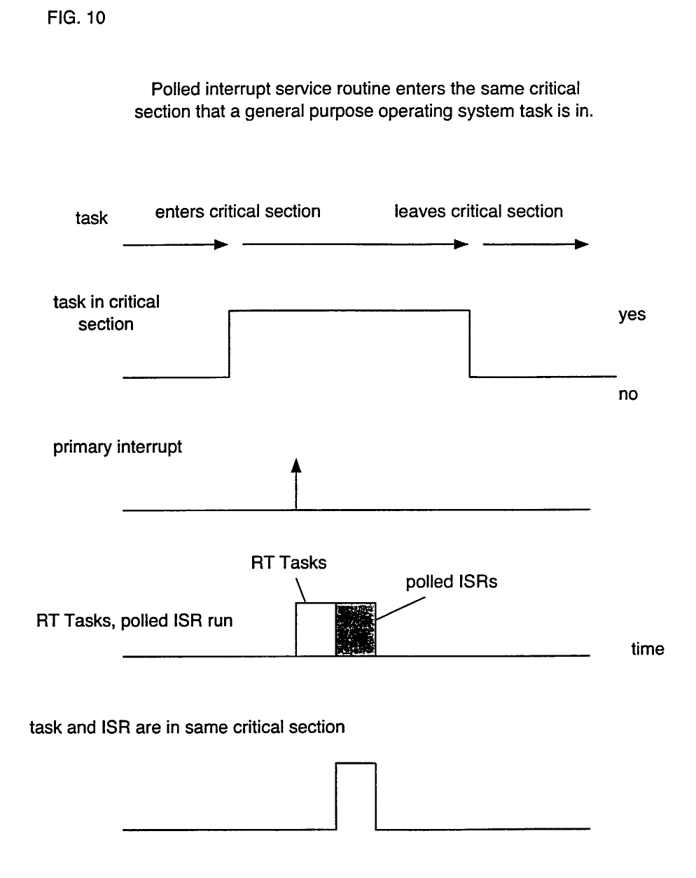

The interrupt service routines that are called by the polling technique are the same ISRs that were previously called from hardware interrupts, so there is still the possibility that a general purpose operating system task and an ISR can contend for access to a shared system resource. This contention was resolved, in the past, by disabling and enabling interrupts around ‘critical sections’ in the tasks and ISRs that accessed shared system resources. However, now that the tasks' disable and enable interrupt instructions have been removed, it is possible that a task will be in a ‘critical section’ when the primary interrupt occurs and calls the polling ISRs, as illustrated in FIG. 10. This would damage the integrity of access to shared system resources, make the general purpose operating system unstable and likely lead to system failure.

If the general purpose operating system is to operate normally, then the polling of devices must be prevented from occurring whenever a general purpose operating system task is in the middle of a ‘critical section’, i.e., atomic access must be granted. ‘Critical sections’ in interrupt service routines are no longer important, because all the ISRs in the system are called sequentially, and there is only one interrupt, which therefore cannot be interrupted by another interrupt.

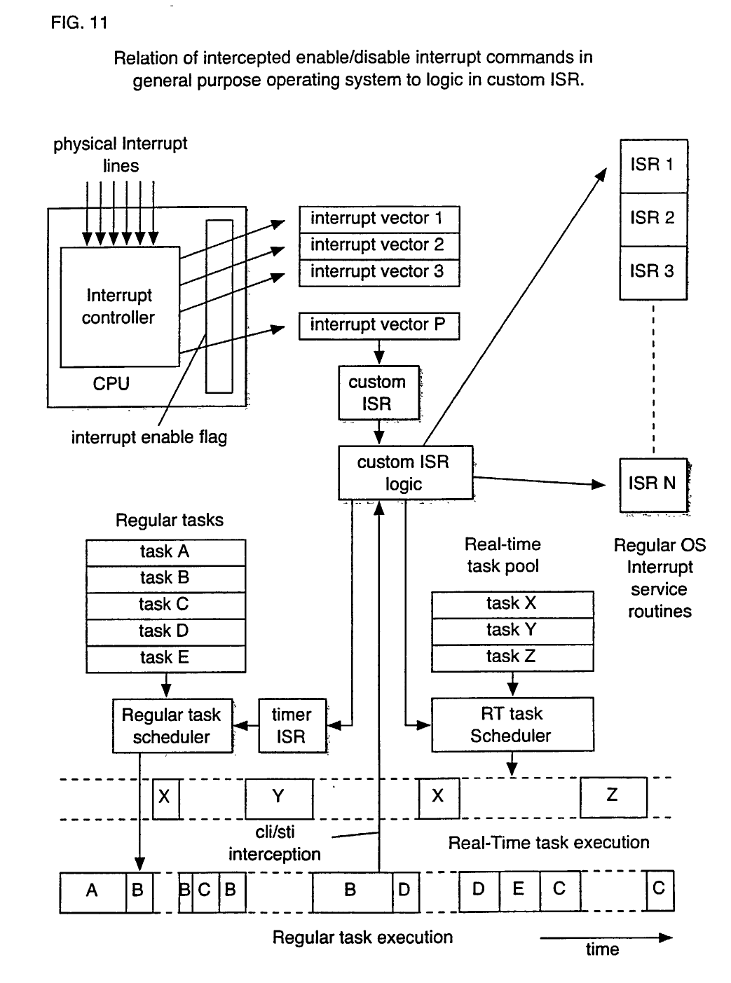

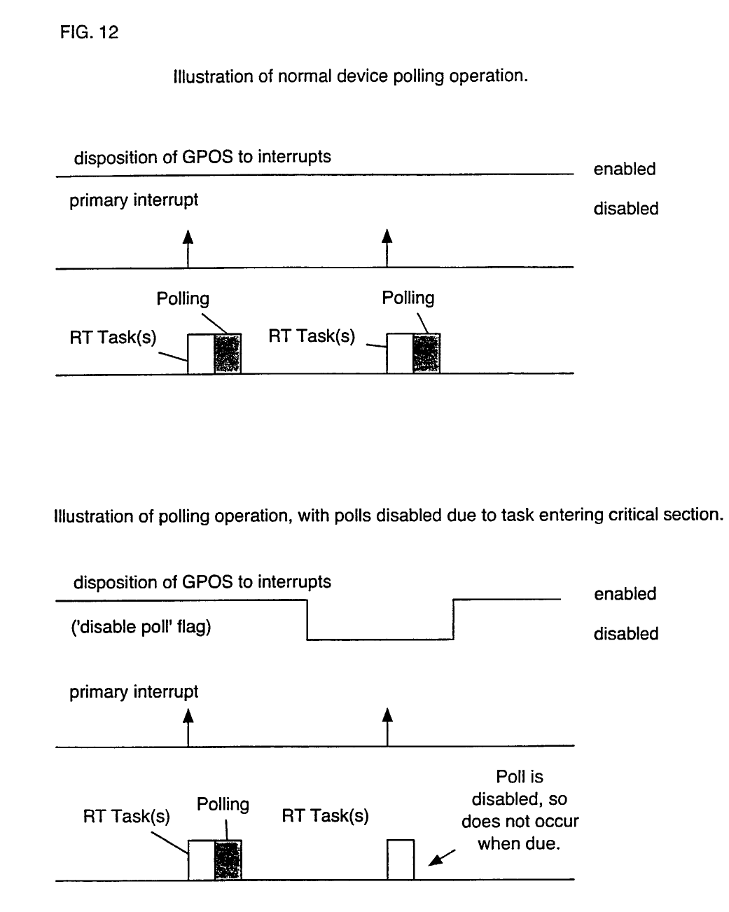

Atomic access to the general purpose operating system tasks' ‘critical sections’ can be enforced with varying degrees of granularity, from treating each ‘critical section’ separately, to treating any ‘critical section’ in the same way. General purpose operating systems are complex, and the source code is not always available, so it is a difficult and laborious process to identify all of the ‘critical sections’ individually, and determine which interrupt service routines use them. It is much simpler to use the fact that the regular tasks try to disable and then re-enable interrupts before and after accessing a ‘critical section’ to identify all ‘critical sections’ that tasks can access. It is possible to intercept these commands and replace then with alternate commands that do not disable and enable interrupts, as has already been discussed, but it is also possible to replace them with versions that set and reset a ‘disable poll’ flag that represents the operating system's disposition to interrupts. This information becomes an input to the logic in the custom ISR, as shown in FIG. 11. The ‘disable poll’ flag indicates whether any task is in a ‘critical section’, and can be used in the primary interrupt custom ISR logic to decide whether a poll is appropriate. If the flag is set, a poll is inappropriate because the general purpose operating system thinks that interrupts are disabled so does not expect the devices' ISRs to be called. Conversely, if the flag is not set when the primary interrupt occurs and it is time to do the polling, then the polling should be carried out. An example of polling being disabled due to a task entering a ‘critical section’ is illustrated in FIG. 12.

In this way, a task that enters a ‘critical section’ prevents any polled device ISRs from running until it leaves the ‘critical section’, without the disabling and enabling of interrupts that would cause real-time task pre-emption. However, this has the effect of skipping some polls that would have otherwise occurred. Depending on the sizes of the data buffers used by the hardware devices in the system, and the frequency that primary interrupts occur, this could lead to loss of data from hardware devices due to the skipped polling. There are three ways to deal with this problem, each with different benefits.

The first approach is to simply ignore the skipped or missed poll as shown in FIG. 12, and to endure the risk that hardware device data could be lost due to buffer overflow. This is justifiable if the data loss can be tolerated in general, or if data loss happens so infrequently in practice that it is tolerable. Weighed against the data loss is the fact that the real-time tasks are not pre-emptible, if skipped polls are ignored this is guaranteed to remain the case, with other approaches this is not necessarily so.

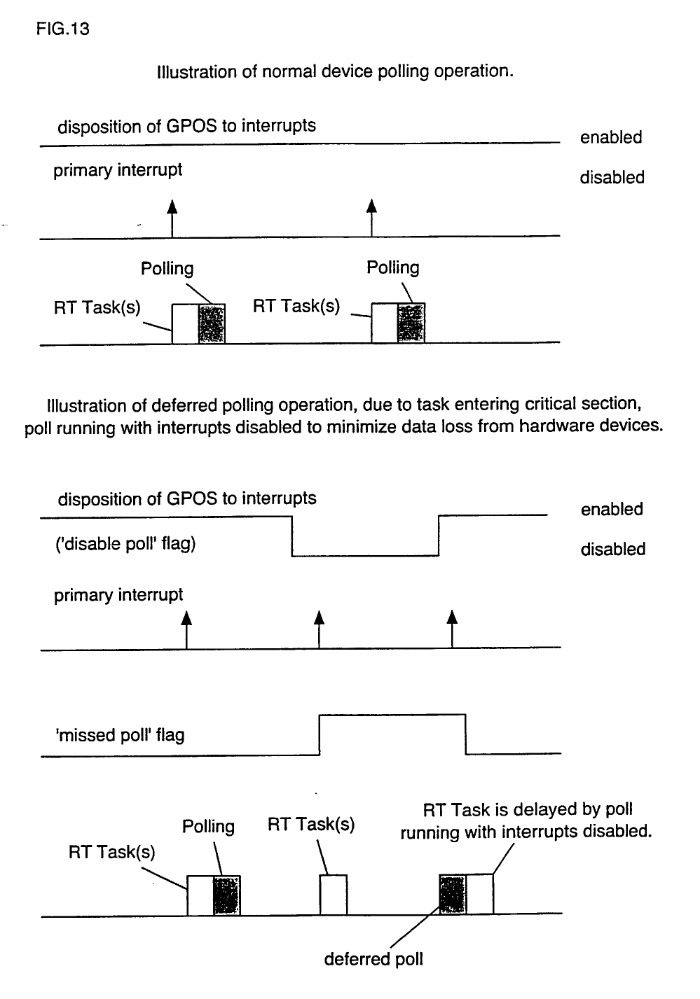

An alternative approach is to try and catch up on a missed poll as soon as possible after the task tries to re-enable interrupts, and in effect resets the ‘disable poll’ flag. To do this, a second, ‘missed poll’ flag is used to register the fact that a poll has been missed. This flags is set when a primary interrupt occurs, and it is determined that a poll/time passage notification is due, but is not allowed to happen because the ‘disable poll’ flag is set. As soon as the general purpose operating system tries to re-enable interrupts, the ‘missed poll’ flag can be read, and if set, the polling and notification of the passage of time can occur. If interrupts are disabled before polling, and notification of the passage of time takes place, and interrupts are enabled afterwards, then it is guaranteed that this whole operation will complete as soon as possible, and data loss will be minimized, if not eradicated. This approach is intended to guarantee that the maximum time in which polling will be skipped is the maximum latency of the unaltered general purpose operating system plus the maximum interval between primary interrupts. One consequence of running the poll and notification of the passage of time with interrupts disabled is that if the primary interrupt occurs during this operation, then the interrupt will be delayed, and so the real-time tasks that run from the interrupt will be pre-empted slightly, introducing a small amount of jitter into the real-time task scheduling, as shown in FIG. 13. This is a trade-off, data loss is minimized at the expense of introducing jitter into the real-time scheduling.

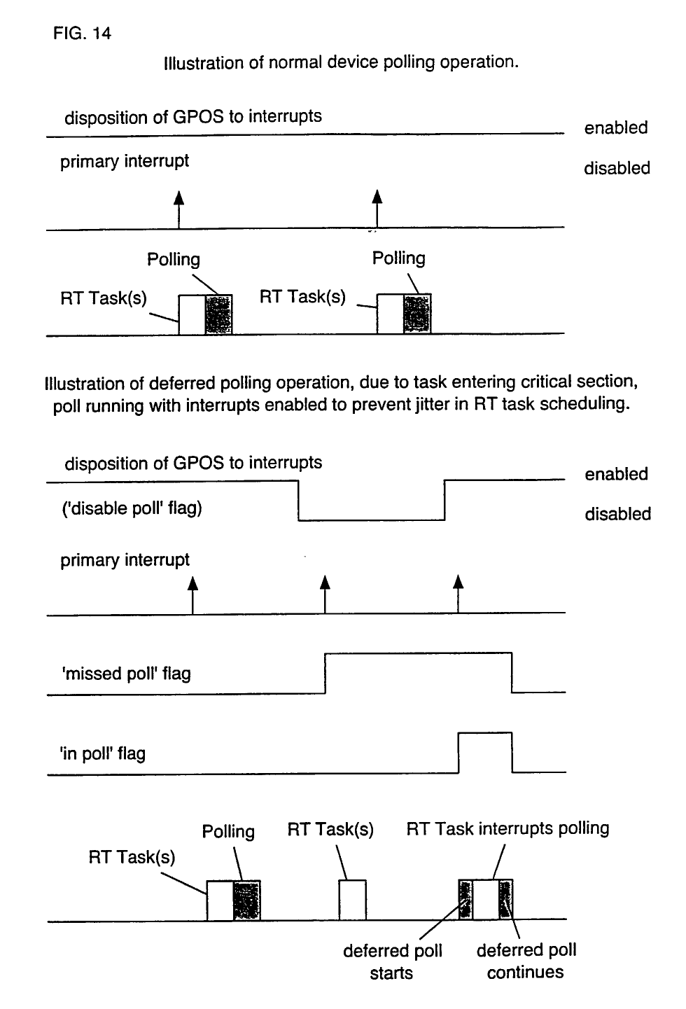

A third approach combines the advantages of the first two, to achieve a minimization of hardware device data loss, and simultaneously attempting to guarantee no pre-emption of the real-time tasks. This approach is identical to the last one, except that the polling and notification of the passage of time that occurs after a missed poll and as soon as the general purpose operating system tries to re-enable interrupts takes place with interrupts enabled. In this case, if the primary interrupt occurs during this operation, its service routine runs immediately, causing the real-time tasks to run if required, and then evaluating whether polling is required. As a polling is already taking place, to make up for the missed poll, the primary interrupt should not call the polling routines again, the polling routines currently running should be allowed to finish before any further polling is contemplated. This is achieved by a third, ‘in poll’ flag that is set whenever a poll/time passage notification is taking place due to a missed poll, and has been called immediately as the general purpose operating system tries to re-enable interrupts. This flag can be used in the primary interrupt's service routine to prevent polling from the primary interrupt, when the interrupt has occurred during a catch-up poll. Once the catch-up poll is completed, the ‘in poll’ flag can be reset. An example of this approach is shown in FIG. 14. Using this method ensures first of all that the real-time tasks cannot be preempted by a catch-up poll, so there is no jitter in real-time task scheduling. The likelihood of hardware device data loss is kept as low as possible, but is slightly more likely than if the second approach were used. This approach guarantees that the maximum time in which polling will be skipped is the maximum latency of the unaltered general purpose operating system plus the maximum interval between primary interrupts, plus the maximum execution time of the real-time tasks. When it is imperative that real-time tasks not be pre-empted for any reason, this is the preferred way of handling missed polls, because it has the minimum possible risk of hardware device data loss without pre-empting the real-time tasks.

These different techniques allow a general purpose operating system to be modified so that real-time tasks can run alongside it, without greatly affecting its operation, but also allow a choice of ways of dealing with missed polls, so that the modifications can be tailored to the requirements of non-preemptibility of real-time tasks under any circumstances, or no hardware device data loss, or a compromise between the two. In conclusion the modifications to the general purpose operating system create a new environment in which two types of tasks can exist, general purpose operating system tasks with unpredictable response times, and real-time tasks with response times that are either entirely deterministic and predictable, or have a very small unpredictability, traded against a lesser likelihood of data loss from hardware devices in the general purpose operating system.

The modifications to a general purpose operating system that have been outlined here result in real-time tasks that should run exactly when they are scheduled, because they cannot be pre-empted. However, the real-time tasks can respond to external events (other than the event that causes the primary interrupt) only as quickly as the interval between primary interrupt occurrences. The real-time tasks are only able to receive and send data from and to hardware devices when they are running, which is during the primary interrupt custom ISR. At these times, the real-time tasks can poll the hardware devices and retrieve or post data to them. Therefore, in order for the real-time tasks to be able to respond quickly to external events, the primary interrupt must be arranged to occur at short intervals. If the interval is arbitrarily short, for example 2 milliseconds, then the response time of the real-time tasks will be a maximum of 2 milliseconds. This is part of the polling philosophy—by polling from the primary interrupt instead of reacting to all external interrupts, it is simpler to add real-time tasks to an operating system, at the expense of a response time that is equivalent to the polling frequency. This response time is deterministic, the main prerequisite for real-time applications, its maximum bound being the interval between primary interrupts, which should be much faster than general purpose operating systems' response times.

The physical implementation of this invention differs depending on whether the source code of the general purpose operating system that is to be modified is freely available or not. If the source code is available the modifications are easy to make to the source code, which can then be recompiled to produce a modified operating system. If the source code is not available, then the binary operating system image, or kernel image can be modified to produce the same results. This can take place as a modification of the operating system image on disk, or as a dynamic alteration of the operating system once it is in memory. For both open and closed source-code cases, the steps taken in modification of a general purpose operating system are the same, only the implementation details differ.

A pristine operating system handles its interrupts, including a timer interrupt to schedule regular tasks as shown in FIG. 2. The modifications to the operating system need to change this arrangement to that of FIG. 7. The steps to do this are as follows:

1) Disable all interrupts except the primary interrupt.

The way this is done is processor-specific, but generally involves masking out interrupts, and/or manipulation of interrupt vectors. For open source operating systems the source code that sets up interrupts initially can be found and modified; for closed source operating systems, the binary image of the operating system has to be searched for the instructions that set up the individual interrupts' status and vectors, and these must be modified. Another approach is to dynamically link a section of code into the operating system image at run-time, which overwrites the interrupt setup and vectors.

2) Set the primary interrupt's vector to point to a custom interrupt service routine (ISR).

This is done in the same manner as (1), for open and closed source operating systems.

3) Replace instructions in the operating system that enable and disable interrupts, with custom replacements.

Enable/disable instructions are processor-specific, but are usually single opcode instructions, or double opcode instructions that involve setting or resetting a bit in a status/control register. For example, in the Intel x86 processor series, the ‘cli’ and ‘sti’ assembler instructions disable and enable interrupts respectively. If the source code to the operating system is available, the source code can be parsed and any occurrence of the cli/sti instructions in the code can be replaced with calls to custom functions. If the source code is not available, the operating system binary image can be searched for the cli/sti opcodes, which can be replaced with calls to custom functions. This is more complex than the open-source equivalent, not least because it involves replacing single-opcode assembly language instructions with multiple-opcode function calls, but it is eminently achievable in an automated manner.

4) Construct and add a real-time task scheduler to the operating system.

This simply involves adding a section of code to the operating system, as source code or compiled code, depending on whether or not the operating system is open source or closed source.

5) Construct and add the custom ISR (as per 2), such that it is aware of the regular tasks' disposition to interrupts (through the custom enable/disable interrupt functions), and calls the real-time task scheduler and the original operating system ISRs as appropriate, using the logic described in the description of the invention.

This step requires that the custom enable/disable interrupt functions modify a data structure that is accessible to the custom ISR routine, and that the custom ISR has access to the real-time task scheduler and the original operating system ISRs. As the custom enable/disable functions and the real-time scheduler are part of the custom additions to the operating system, along with the custom ISR, it is simple for the custom ISR to access the real-time scheduler, and for the custom enable/disable interrupt functions to modify a structure that is accessible from the custom ISR. In step 1, the original operating system ISRs were removed or disabled. These ISRs still exist in the operating system image, and their addresses are known, as part of the removal process, so that the custom ISR has easy access to these routines.

The preferred embodiment of this invention is as a modification to the Linux operating system. Linux is chosen because it is a widely-used open-source operating system that runs on many different processors. As an open source operating system, it is possible to access and modify things like the interrupt vectors and interrupt setup in a high-level way that is to a certain extent processor independent, reducing the work involved in applying this modification to Linux running on a range of different processors. Linux is modified in two ways in the preferred embodiment. Firstly by making modifications to the pristine Linux kernel source code, and secondly by creating and inserting a Linux kernel module, which is dynamically linkable to the rest of the active Linux kernel, and provides the extra functionality of turning on or off the added features with its insertion and removal.

Step 1 and 2 are achieved upon insertion of the kernel module, that examines the current interrupt setup, using high level data structures provided by Linux, and then disables all the interrupts except the primary interrupt, using the high-level Linux function ‘disable_irq’ which is hardware-independent. Also at this point the current registered interrupt service routines are read from the high level interrupt setup structures provided by Linux, and stored for future use. The primary interrupt's interrupt service routine is changed to point to a custom ISR provided by the kernel module.

Step 3 is achieved by parsing the Linux kernel source code for any instructions that disable or enable interrupts and replacing them with custom alternatives. There are two classes of instructions like this in Linux, high level functions that ultimately enable and disable interrupts, such as ‘local_irq_enable( )’, ‘local_irq_disable( )’, ‘cli( )’ and ‘sti( )’, which are processor-independent, and there are also raw occurrences of the individual assembler opcodes that enable and disable interrupts, which on the Intel x86 processor appear as the source code sequences:

_asm_{——}volatile_(“cli”:::“memory”)

_asm_{——}volatile_(“sti”:::“memory”)

Both the high level processor-independent and the low level processor-specific enable/disable instructions must be intercepted and replaced with custom functions. In the preferred embodiment the custom functions each use a function pointer that originally points to a routine that actually does enable or disable interrupts, but once the kernel module is inserted, this function pointer points to a routine that does not enable or disable interrupts, but communicates Linux's disposition towards interrupts to the custom ISR in the kernel module. These function pointers are used so that the extra functionality provided by this invention can be switched on or off by insertion and removal of the kernel module.

Step 4 and 5 are provided by the insertion kernel module, which contains a real-time scheduler, and a custom ISR which uses the logic described in this invention to call the real-time scheduler and the original ISRs at appropriate times. The kernel module also provides a means to manipulate the real-time task scheduler. Entry points are provided so that additional kernel modules can be inserted which add real-time tasks that can be run by the scheduler, and adjust the parameters of the scheduler.

By means of these steps, a pristine Linux kernel is modified so that the insertion and removal of a kernel module can add and remove the functionality provided by this invention, and when the functionality is active, additional kernel modules can be inserted which add/modify/remove real-time tasks from the real-time scheduler. The only parts of this modification which are processor-specific under Linux are the replacement of the low level assembler opcodes that enable and disable interrupts in the source code, some task-switching stack manipulation done in the real-time scheduler and exception handling, reducing the amount of work involved in porting this modification from Linux on one processor to Linux on another processor. Current trends in the ongoing development of the Linux operating system indicate that in time, less and less processor-specific components will be part of the operating system, making the modifications to implement this invention for Linux easier as development of Linux progresses.

### EXAMPLES OF CUSTOM ISR OPERATION

The following examples illustrate various ways in which the custom ISR can be used to run one or more real-time tasks.

### Example 1

### Single Periodic RT Task, Running on the Linux Operating System, Modified as per this Invention, on an Intel x86 Processor

This is useful for multimedia applications, anything that processes audio or video data streams. As audio and video streams are primarily constant data rate streams, or at least have fixed maximum data rates, the single real time task in this example needs to run periodically. The primary interrupt in this case is the hardware timer interrupt, which is set, upon initialization to a value set in a given file in the Linux operating system source code, defined as HZ, meaning per second (i.e., as in the term Hertz, which is the common unit of measure for cycles per second). An HZ value of 500 will cause the timer interrupt to be generated every 2 ms. In the Linux source code, the function ‘timer_interrupt( )’ is called when the timer interrupt occurs, this does some housekeeping associated with system timing, then calls the function ‘do_timer_interrupt( )’ which in turn calls the function ‘do_timer( )’, which marks a bottom half handler to be executed as soon as the interrupt is over. The timer interrupt bottom half handler is the part of the timer interrupt response that calls the scheduler to potentially switch processes, and generally keeps the operating system informed of the passage of time.

In this case, as the primary interrupt is the timer interrupt, all other interrupts are disabled in the modified operating system, and the time r interrupt ISR is replaced by a custom ISR. The custom ISR is a modified version of the function ‘timer_interrupt( )’, that does the following:

1) Does the timer housekeeping that was done by the unmodified function.

2) Calls a function that does all the real-time audio/video processing, this is the single real-time task.

3) If allowed by knowledge of Linux disposition towards interrupts poll all hardware devices by calling all the ISRs registered to Linux by devices, then call the function do_timer_interrupt( ), which calls ‘do_timer( )’, which marks the timer interrupt bottom half handler, which will be called as soon as the timer interrupt is done.

The device polling is accomplished by a new function that examines the data structures maintained by Linux, that represent the interrupt service routines registered by device drivers, and uses these data structures to call every ISR registered by every device driver in sequence. This has the effect of simulating to Linux that at some point in the last 2 ms time interval, every one of these interrupts has occurred, letting Linux operate as normal with respect to the hardware devices. Calling the ‘do_timer_interrupt( )’ function indirectly causing the timer interrupt bottom half handler to run, has the effect of simulating to Linux that a period of time has elapsed.

In this way, a single real-time task is run without danger of pre-emption every 2 ms. This real-time task has an impression of the passage of time, by virtue that it is called periodically, but it also needs to be able to send and receive information to the outside world. To receive information, the real time task can poll the hardware devices using custom routines, that only read the data from devices, and do not notify devices that it has read the data, leaving this for Linux to do, which also sees the same data. To send information, a difficulty arises, as the real-time task could be trying to send information out of a hardware device when a general purpose task is also in the middle of doing so, violating atomic access to a shared system resource. To get around this, the real-time task can also have a series of buffers for sent data, and an associated bottom half handler, that handles passing these buffers to the generic device send routines, but respecting atomic access to shared system resources. This would work because the way bottom half handlers work, if the timer interrupt occurred when a process was trying to send data from a device, using a system call or software interrupt, then the bottom half handler would only be called once the system call was complete. This preserves atomic access to shared system resources with respect to sending data from the real-time task.

### Example 2

### Multiple RT Tasks, Running on the Linux Operating System, Modified as per this Invention, on an Intel x86 Processor, Using the Timer Interrupt as Primary Interrupt

This is the most general case, in which the real-time tasks run at different rates, controlled by a real-time scheduler. T his differs from the above case only slightly, much is the same, including the timer interrupt as the primary interrupt. This differs from the above as follows:

When the timer interrupt occurs, the custom ISR does not automatically call a RT task function, and does not automatically try and poll devices and call ‘do_timer_interrupt( )’. Instead, it examines the current time, how long it has been since the devices were polled, and the real-time scheduler to see if it is time to call one of the real-time task functions. If it is time to call one or more of the RT task functions, these will be called immediately. Next, if it is time to poll the devices and call ‘do_timer_interrupt( )’, this will be done now, if allowed by Linux's current disposition towards interrupts. Finally, a determination is made as to when the next timer interrupt should occur, based upon when the RT tasks need to run, and when the next poll should occur. Based upon this determination, the timer hardware will be modified to schedule a time interrupt at the time that meets these goals.

### Example 3

### Multiple RT Tasks, Running on the Linux Operating System, Modified as per this Invention, on an Intel x86 Processor, Using the Universal Serial Bus (USB) End of Frame Interrupt as the Primary Interrupt

This is very similar to the above case, except that the USB controllers can only generate interrupts every 1 ms, or multiples of this. If the USB controller is set up to generate an interrupt every 1 ms, then when this occurs, the custom ISR examines the RT scheduler to determine whether one or more RT tasks should run, and if necessary calls these immediately. Next the custom ISR examines how long in terms of 1 ms USB ticks it has been since the last device poll, and call to ‘do_timer_interrupt( )’, and if necessary, polls the devices and calls ‘do_timer_interrupt( )’.

### Example 4

### Multiple RT Tasks, Running on the Linux Operating System, Modified as per this Invention, on an Intel x86 Processor, Using an Ethernet Card Interrupt as the Primary Interrupt

In this case, the primary interrupt will occur, depending on the ethernet card used, when a packet arrives from the network, when the cards transmit buffer is empty, receive buffer is full, or in similar packet-related cases. These occur at unpredictable intervals of time, meaning that this is not well suited to running RT tasks with hard timing requirements, unless ethernet interrupts occur very frequently.

When the custom ISR is called, it must as in the above cases examine the RT scheduler to see which if any RT tasks should run at this moment, and run these tasks. Next, the custom ISR must examine how long it has been since the last polling of the devices, and call to ‘do_timer_interrupt( )’. If this is long enough, the devices must be polled, and ‘do_timer_interrupt( )’ must be called.

What is claimed is:

1. A process for running real-time tasks alongside a general-purpose operating system, in which the general purpose operating system is prevented from pre-empting the real-time tasks, comprising:
disabling all hardware interrupts on a system except a single, primary interrupt,
changing a primary interrupt's service routine from a general purpose operating system's service routine for the primary interrupt, to a custom interrupt service routine,
modifying the general purpose operating system so that it is prevented from disabling the primary interrupt, when doing so would preempt a real-time task.

2. The process of claim 1, wherein the custom interrupt service routine associated with the primary interrupt passes control to at least one real-time task on the system.

3. The process of claim 2, wherein the general purpose operating system is modified to behave as if all interrupts were still active, by a method comprising:
determining whether sufficient time has elapsed to warrant polling hardware devices and, if so, polling the hardware devices at the end of the primary interrupt's custom service routine,
notifying the general purpose operating system of any external events that have occurred,
periodically notifying the general purpose operating system that a fixed amount of time has elapsed, at intervals approximately equal to the rate at which the general purpose operating system expect timer interrupts.

4. The process of claim 3, wherein the polling of hardware devices, notification of external events, and notification that a fixed amount of time has elapsed is accomplished by calling the general purpose operating system's interrupt service routines for the interrupts that are used by hardware devices, and the general purpose operating system's timer interrupt service routine.

5. The process according to claim 4, comprising determining when to pass control to real-time tasks, when to poll hardware devices and when to inform the general purpose operating system of the passage of a unit of time, using logic in the primary interrupt's custom service routine.

6. The process of claim 5, comprising, in the case where the primary interrupt is a timer interrupt, rescheduling the timer interrupt to occur some time in the future, to meet the real-time tasks' scheduling needs, the requirement to poll external hardware devices at a sufficient rate, and periodically notify the general purpose operating system that a unit of time has passed, using logic in the primary interrupt's custom service routine.

7. The process of claim 5, comprising, in the case where the primary interrupt is a periodic fixed-rate interrupt, determining when to pass control to real-time tasks, and when to poll external hardware devices and notify the general purpose operating system that a unit of time has passed, using logic in the primary interrupt's service routine that counts the number of periodic primary interrupts that have occurred.

8. A process according to claim 1, comprising providing atomic data transfer between hardware devices and the general purpose operating system, to prevent simultaneous access to shared system resources.

9. The method of claim 8, wherein a mutual exclusion mechanism prevents the general purpose operating system code that accesses shared system resources pertaining to hardware devices from being called from an interrupt service routine when the shared system resources are already being accessed.

10. The process of claim 9, comprising atomically transferring data between the general purpose operating system and the hardware devices by maintaining a series of independent atomically settable and re-settable flags that are set and reset when the general purpose operating system enters and leaves code that accesses individual shared resources pertaining to hardware devices, and using these flags to prevent individual hardware devices from being polled during these periods of time.

11. The process of claim 9, wherein atomic transfer of data between the general purpose operating system and hardware devices is achieved by maintaining a single atomically settable and re-settable flag that is set and reset when the general purpose operating system enters and leaves code that accesses any shared resource that pertains to hardware devices, and using this flag to prevent hardware device polling and notification that a unit of time has elapsed during this period of time.

12. The process of claim 9, wherein atomic transfer of data between the general purpose operating system and hardware devices is achieved by maintaining a disable poll flag that is atomically set and reset whenever the general purpose operating system tries to disable and enable interrupts, and using the disable poll flag to prevent hardware device polling and notification that a unit of time has elapsed whenever the general purpose operating system expects interrupts to be disabled.

13. The process of claim 12, comprising a method for inhibiting pre-emption of the real-time tasks running on the system, during the period of time in which polling is disabled, by the steps of:
allowing only the primary interrupt to occur, from which non pre-emptible, real-time tasks are run,
disallowing the primary interrupt to poll devices or notify the general purpose operating system of the passage of a unit of time.

14. The process of claim 12, comprising, after the period of time in which polling is disabled, minimize data loss from the hardware devices by:
setting and resetting a ‘disable poll’ flag that prevents hardware polling and notification of the passage of time from occurring, whenever the general purpose operating system tries to enable or disable interrupts,
if the primary interrupt occurs while the ‘disable poll’ flag is set, determining if enough time has elapsed since the last hardware polling or time passage notification to warrant another poll and time passage notification, and
setting another ‘missed poll’ flag to indicate that a hardware poll and time passage notification is needed as soon as possible,
wherein, whenever the general purpose operating system tries to re-enable interrupts, after trying to disable them, if the ‘missed poll’ flag is set, disabling interrupts, polling the hardware devices, notifying the general purpose operating system of the passage of a unit of time, and resetting the ‘missed poll’ flag and re-enabling interrupts.

15. The process of claim 12, comprising:
after the period of time in which polling is disabled, causing hardware device polling and the general purpose operating system to be notified of the passage of a unit of time, to minimize data loss of data from hardware devices, and inhibiting pre-emption of real-time tasks, by:
whenever the general purpose operating system tries to enable or disable interrupts, setting and resetting a disable poll flag that prevents hardware polling and notification of the passage of time from occuring,
if the primary interrupt occurs while the hardware poll or time passage notification prevention flag is set, determining whether enough time has elapsed since the last hardware polling or time passage notification to warrant another poll and time passage notification, then setting another missed poll flag to indicate that a hardware poll and time passage notification is needed,
wherein, whenever the general purpose operating system tries to re-enable interrupts, after trying to disable them, if the ‘missed poll’ flag is set, then setting an in poll flag, polling the hardware devices, notifying the general purpose operating system of the passage of a unit of time, and resetting the missed poll flag and the in poll flag,
if a primary interrupt occurs while the in poll flag is set, allowing real-time tasks to be run from the interrupt, and preventing any polling or notification of the passage of time from occurring.

16. A process for running real-time tasks alongside a general-purpose operating system, in which the general purpose operating system is prevented from pre-empting the real-time tasks, comprising:
disabling all hardware interrupts on a system except a single, primary interrupt,
changing a primary interrupt's service routine from a general purpose operating system's service routine for the primary interrupt, to a custom interrupt service routine, and
modifying the general purpose operating system so that it cannot disable the primary interrupt.
